(19) United States
(12) Patent Application Publication
(10) Pub. No.: US 2017/0086264 A1
(43) Pub. Date: Mar. 23, 2017

(54) MICROWAVE HEATING DEVICE

(71) Applicants: GUANGDONG MIDEA KITCHEN APPLIANCES MANUFACTURING CO., LTD., Foshan (CN); MIDEA GROUP CO., LTD., Foshan (CN)

(72) Inventors: Jianyi ZHOU, Foshan (CN); Yongzhong ZHANG, Foshan (CN); Jian LONG, Foshan (CN)

(21) Appl. No.: 14/865,014

(22) Filed: Sep. 25, 2015

(30) Foreign Application Priority Data
Sep. 21, 2015 (CN) 201520732485.3
Sep. 21, 2015 (CN) 201520732502.3

(51) Int. Cl. H05B 6/64

(52) U.S. Cl. CPC H05B 6/6423; H05B 6/6402; H05B 6/6414

(57) ABSTRACT

A microwave heating device is provided. The microwave heating device includes: an oven body defining a microwave heating chamber and an electrical component installing chamber therein, the electrical component installing chamber communicating with outside air via a plurality of kinds of vents; a drawer door movably installed on the oven body to open and close the microwave heating chamber; and a control box installed on the oven body and located above the drawer door; wherein at least one of the control box and the oven body has at least one kind of vents of the plurality of kinds of vents.

### CROSS REFERENCE TO RELATED APPLICATIONS

This U.S. application claims priority and benefit of prior Chinese Application No. 201520732502.3 and 201520732485.3 filed Sep. 21, 2015. The entire contents of the before-mentioned patent applications are incorporated by reference as part of the disclosure of this U.S. application.

### FIELD

Embodiments of the present disclosure generally relate to a field of electrical appliances, and more particularly, to a microwave heating device.

### BACKGROUND

A drawer-typed microwave oven in the related art takes in cold air and discharges hot air through a louver provided in a top of a drawer. Therefore, a wide gap (commonly about 10 mm) exists between a control box and a drawer door so as to provide a passage of the cold air or the hot air. Viewed from the front of a product, the wide gap existing between the control box and the drawer door affects appearance integrality of the microwave oven.

### SUMMARY

Embodiments of the present disclosure seek to solve at least one of the problems existing in the related art to at least some extent. Accordingly, embodiments of the present disclosure provide a microwave heating device, which has good appearance integrality and does not affect cold air suction and hot air discharge of the microwave heating device.

The microwave heating device according to embodiments of the present disclosure includes: an oven body defining a microwave heating chamber and an electrical component installing chamber therein, the electrical component installing chamber communicating with outside air via a plurality of kinds of vents; a drawer door movably installed on the oven body to open and close the microwave heating chamber; and a control box installed on the oven body and located above the drawer door; in which at least one of the control box and the oven body has at least one kind of vents of the plurality of kinds of vents.

With the microwave heating device according to embodiments of the present disclosure, the good appearance integrality and leakproofness are obtained, and the cold air suction and hot air discharge of the microwave heating device are not affected.

In an embodiment of the present disclosure, the at least one kind of vents of the plurality of kinds of vents is provided in the control box.

In an embodiment of the present disclosure, the at least one kind of vents of the plurality of kinds of vents is provided in a front surface of the control box.

In an embodiment of the present disclosure, the control box includes a control panel facing forwards and the control panel avoids vents disposed in the front surface of the control box.

In an embodiment of the present disclosure, rest kinds of vents of the plurality of kinds of vents apart from the at least one kind of vents provided in the control box are provided in the drawer door.

In an embodiment of the present disclosure, the rest kinds of vents of the plurality of kinds of vents are provided in a bottom wall of the drawer door.

In an embodiment of the present disclosure, a plurality of kinds of intercommunicated holes is provided in the oven body, and the plurality of kinds of vents respectively communicates with the electrical component installing chamber via the plurality of kinds of intercommunicated holes.

In an embodiment of the present disclosure, the plurality of kinds of vents includes an air inlet and an air outlet, one of the air inlet and the air outlet is provided in the control box and the other one of the air inlet and the air outlet is provided in the drawer door.

In an embodiment of the present disclosure, the plurality of kinds of vents includes an air inlet, an air outlet and an auxiliary air port, the air inlet and the air outlet are provided in one of the control box and the drawer door, and the auxiliary air port is provided in the other one of the control box and the drawer door.

In an embodiment of the present disclosure, the at least one kind of vents of the plurality of kinds of vents are provided in the oven body and between the control box and the drawer door, and a baffle is disposed on the one of the drawer door and the control box so as to shield a portion of the gap between the control box and the drawer door.

In an embodiment of the present disclosure, the baffle is disposed on the drawer door, extends towards the control box from the drawer door, and spaced away from the control box.

In an embodiment of the present disclosure, a front surface of the baffle is in flush with a front surface of the drawer door.

In an embodiment of the present disclosure, a boss is disposed on the control box and protruded towards the drawer door, the at least one kind of vents of the plurality of kinds of vents is located between the control box and the drawer door, the boss is located behind the baffle and a lowest point of the boss is lower than a highest point of the baffle.

In an embodiment of the present disclosure, the baffle is disposed on the control box, and extends towards the drawer door from the control box, and spaced away from the drawer door.

In an embodiment of the present disclosure, a front surface of the baffle is in flush with a front surface of the control box.

In an embodiment of the present disclosure, rest kinds of vents of the plurality of kinds of vents apart from the at least one kind of vents provided in the oven body are provided in the drawer door.

In an embodiment of the present disclosure, the rest kinds of vents of the plurality of kinds of vents apart from the at least one kind of vents provided in the oven body are provided in a bottom wall of the drawer door.

In an embodiment of the present disclosure, at least one kind of intercommunicated holes is provided in the oven body, and the plurality of kinds of vents respectively communicates with the electrical component installing chamber via a corresponding kind of intercommunicated holes.

In an embodiment of the present disclosure, the plurality of kinds of vents includes an air inlet and an air outlet, one of the air inlet and the air outlet is provided in the oven body and the other one of the air inlet and the air outlet is provided in the drawer door.

In an embodiment of the present disclosure, the plurality of kinds of vents includes an air inlet, an air outlet and an auxiliary air port, the air inlet and the air outlet are provided in one of the oven body and the drawer door, and the auxiliary air port is provided in the other one of the oven body and the drawer door.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a front view of a microwave heating device according to an embodiment of the present disclosure;

FIG. 2 is a cross-sectional view of a microwave heating device according to an embodiment of the present disclosure;

FIG. 3 is a front view of a microwave heating device according to a first embodiment of the present disclosure;

FIG. 4 is a cross-sectional view of a microwave heating device according to a first embodiment of the present disclosure;

FIG. 5 is a front view of a microwave heating device according to a second embodiment of the present disclosure;

FIG. 6 is a cross-sectional view of a microwave heating device according to a second embodiment of the present disclosure;

FIG. 7 is a front view of a microwave heating device according to a third embodiment of the present disclosure; and

FIG. 8 is a cross-sectional view of a microwave heating device according to a third embodiment of the present disclosure.

### REFERENCE NUMERALS

Microwave heating device 100,
Oven body 1, microwave heating chamber 10, electrical component installing chamber 11, vent 12, air inlet 121, air outlet 122, air-out intercommunicated hole 13, air-in intercommunicated hole 14,
Drawer door 2, baffle 21, control box 3, boss 31, fan 4, magnetron 5, waveguide tube 6.

### DETAILED DESCRIPTION

Reference will be made in detail to embodiments of the present disclosure. Embodiments of the present disclosure will be shown in drawings, in which the same or similar elements and the elements having same or similar functions are denoted by like reference numerals throughout the descriptions. The embodiments described herein according to drawings are explanatory and illustrative, not construed to limit the present disclosure.

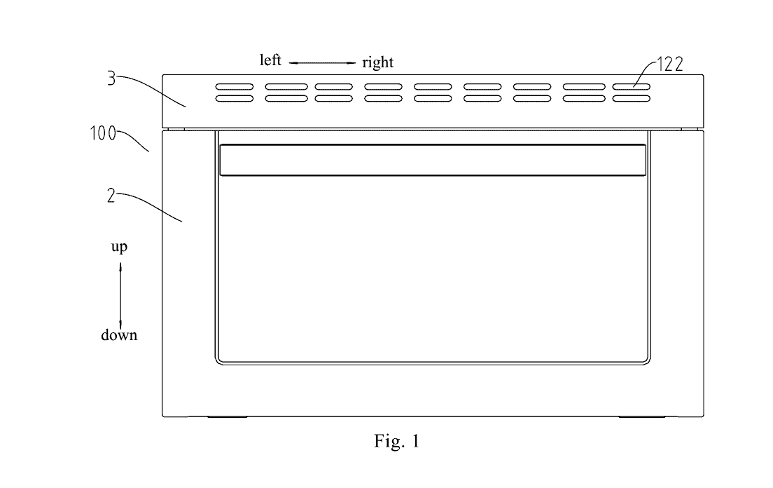

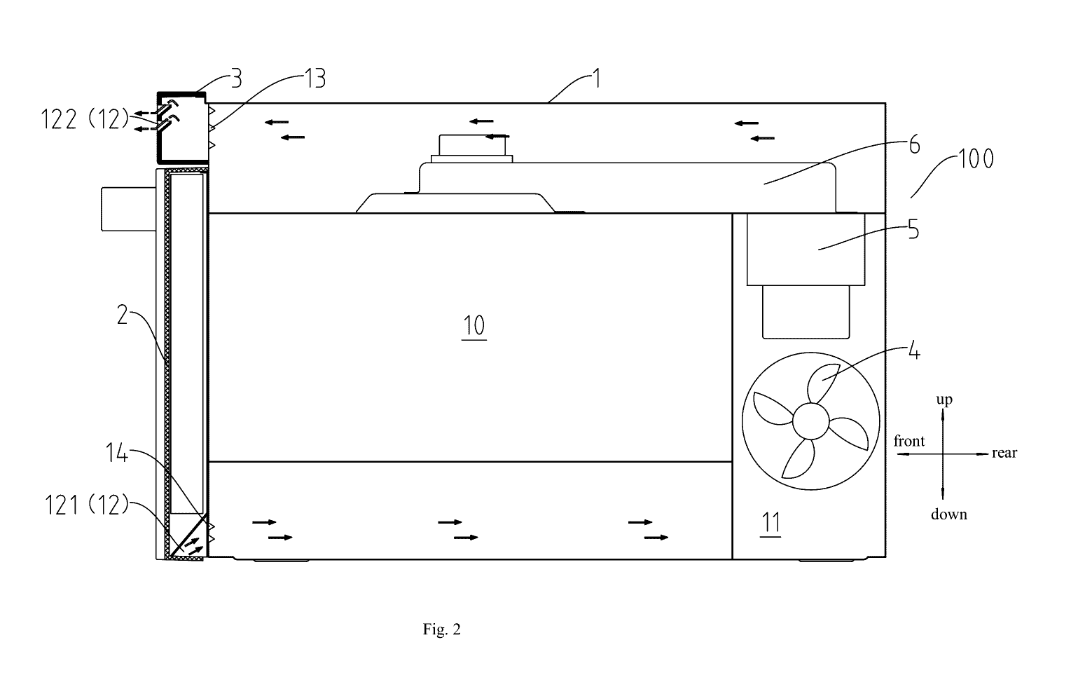

A microwave heating device 100 according to embodiments of the present disclosure will be described in the following with reference to FIGS. 1 and 2. The microwave heating device 100 has good appearance integrality and can take in cold air and discharge hot air so as to cool heating components and parts, thus improving a cooking effect.

Specifically, the microwave heating device 100 may be microwave oven or a microwave roaster embedded into a wall or a cabinet.

As shown in FIGS. 1 and 2, the microwave heating device 100 according to embodiments of the present disclosure includes an oven body 1, a drawer door 2 and a control box 3.

Specifically, the oven body 1 has a microwave heating chamber 10 and an electrical component installing chamber 11 therein. Food to be heated is placed in the microwave heating chamber 10 to be heated in a microwave way, and the electrical component installing chamber 11 is adapted to install electrical components required by microwave heating. The electrical component includes a fan, a magnetron, a waveguide tube, a transformer, a capacitor and so on. It should be noted that, the electrical component in embodiments of the present disclosure is not limited to this, and may be any electrical component used in the microwave heating device 100.

The electrical component installing chamber 11 has a plurality of kinds of vents 12 communicating with outside air. In this way, external cold air enters into the electrical component installing chamber 11 through a kind of vents 12 to cool the electrical components and then turns into hot air, and the hot air is discharged from another kind of vents 12, thus forming an air channel for air passage. Moreover, in above process, the flowing air have the heating in the microwave heating chamber 10 performed evenly, so as to improve a cooking effect of food. Unidirectional arrows in FIG. 2 are to indicate a flowing path of the air in the electrical component installing chamber 11, i.e., the above air channel. It may be understood that, the plurality of kinds of vents 12 at least includes an air outlet 122 and an air inlet 121.

The drawer door 2 is movably installed on the oven body 1 to open and close the microwave heating chamber 10, so that it is convenient for a user to put the food to be heated into the microwave heating chamber 10 or to take the food out of the microwave heating chamber 10. As shown in the drawings, the microwave heating device 100 is in a state in which the drawer door 2 closes the microwave heating chamber 10, and then the microwave heating device 100 can heat the food in the microwave heating chamber 10.

The control box 3 is installed on the oven body 1 and located above the drawer door 2. At least one kind of vents of the plurality of kinds of vents 12 is provided in the control box 3, that is to say, all of the plurality of kinds of vents 12 may be provided in the control box 3, only one kind of vents 12 may be provided in the control box 3 or two kinds of vents 12 may be provided in the control box 3. Thus, cold air may enter into the electrical component installing chamber 11 from the control box 3, or hot air may be discharged out of the electrical component installing chamber 11 from the control box 3 so that a gap between the control box 3 and the drawer door 2 can be reduced. Therefore, the microwave heating device 100 has improved appearance integrality and leakproofness. For example, as shown in FIG. 2, the air outlet 122 is provided in the control box 3.

With the microwave heating device 100 according to the embodiments of the invention, since at least one kind of vents of the plurality of kinds of vents 12 is provided in the control box 3, it does not need to provide the vent 12 in a part of the oven body 1 between the control box 3 and the drawer door 2, and thus the gap between the control box 3 and the drawer door 2 is not needed, as long as it is ensured that the drawer door 2 can be opened and closed normally. Therefore, appearance integrality and leakproofness of the microwave heating device 100 are improved, and the cold air suction and the hot air discharge of the microwave heating device 100 are not affected.

It should be noted that, following descriptions of the microwave heating device 100 are performed in the state in which the drawer door 2 closes the microwave heating chamber 10.

In some embodiments of the present disclosure, the at least one kind of vents of the plurality of kinds of vents 12 is provided in a front surface of the control box 3, and thus the hot air in the electrical component installing chamber 11 can be discharged successfully. For example, as shown in FIGS. 1 and 2, the air outlets 122 of the plurality of kinds of vents 12 are provided in the front surface of the control box 3.

In an optional embodiment as shown in FIG. 1, the vent 12 provided in the front surface of the control box 3 may be an obround hole extended in a left and right direction, and thus the vent 12 has a large ventilation area, which facilitates ensuring a heat dissipation efficiency of the microwave heating device 100. It may be understood that, a shape of the vent 12 is not limited, and the vent 12 also may be a hole having another shape, such as a rectangle shape or an oval shape.

In some embodiments, the vents 12 provided in the front surface of the control box 3 may be arranged in a plurality of rows in the left and right direction and in a plurality of columns in an up and down direction respectively, and thus appearance aesthetics of the microwave heating device 100 is improved, and the ventilation area in the front surface of the control box 3 is increased, which facilitates increasing an amount of the cold air entering into the electrical component installing chamber 11 or an amount of the hot air discharged out of the electrical component installing chamber 11, thus further reducing the gap between the control box 3 and the drawer door 2.

In further embodiments of the present disclosure, the control box 3 includes a control panel (not shown) facing forwards and the control panel avoids vents 12 disposed in the front surface of the control box 3. Thus, a user can control working conditions of the microwave heating device 100 by using the control panel, and an operation thereof is convenient.

In some embodiments of the present disclosure, rest kinds of vents 12 of the plurality of kinds of vents 12 apart from the kind of vents 12 provided in the control box 3 may be provided in the drawer door 2, and thus the cold air can flow in the air channel among the control box 3, the electrical component installing chamber 11 and the drawer door 2, and the cold air can also flow through the microwave heating device 100 in the up and down direction and in the left and right direction. For example, as shown in FIG. 2, the plurality of kinds of vents 12 includes the air outlet 122 and the air inlet 121, in which the air outlet 122 is provided in the control box 3, and the air inlet 121 is provided in the drawer door 2. Thus, the cold air enters the electrical component installing chamber 11 through the air inlet 121, cools the electrical components in the air channel while flowing towards the air outlet 122, and finally turns into the hot air and the hot air is discharged from the air outlet 122.

Furthermore, as shown in FIG. 2, the rest kinds of vents 12 of the plurality of kinds of vents may be provided in a bottom wall of the drawer door 2. Therefore, a length of the air channel is increased, and the cold air can flow through the whole electrical component installing chamber 11, thus further enhancing the heat dissipation efficiency of the microwave heating device 100 and improving the cooking effect of the microwave heating chamber 10 at the same time.

In some embodiments, a plurality of kinds of intercommunicated holes is provided in the oven body 1, and the plurality of kinds of vents 12 respectively communicates with the electrical component installing chamber 11 via the plurality of kinds of intercommunicated holes. For example, as shown in FIG. 2, the air outlet 122 communicates with the electrical component installing chamber 11 via an air-out intercommunicated hole 13, and the air inlet 121 communicates with the electrical component installing chamber 11 via an air-in intercommunicated hole 14. Thus, the cold air entering the microwave heating device 100 through the air inlet 121 enters the electrical component installing chamber 11 through the air-in intercommunicated hole 14, and finally the hot air is discharged to the air outlet 122 through the air-out intercommunicated hole 13 and is further discharged out of the microwave heating device 100.

As shown in FIG. 2, according to an embodiment of the present disclosure, the plurality of kinds of vents 12 includes the air inlet 121 and the air outlet 122, one of the air inlet 121 and the air outlet 122 is provided in the control box 3 and the other one of the air inlet 121 and the air outlet 122 is provided in the drawer door 2. In other words, as shown in FIG. 2, the air outlet 122 may be provided in the control box 3 and the air inlet 121 may be provided in the drawer door 2. Thus, the cold air flows into the electrical component installing chamber 11 through a lower portion thereof and flows backwards to a rear wall of the electrical component installing chamber 11, and then the cold air flows upwards to a top wall of the electrical component installing chamber 11 and finally flows forwards to the control box 3 and the hot air formed therein is discharged from the air outlet 122. In above processes, the cold air cools the electrical component while flowing therethrough, and unidirectional arrows in FIG. 2 indicate flowing directions of the cold air and the hot air respectively.

Certainly, the air inlet 121 may be provided in the control box 3 and the air outlet 122 may be provided in the drawer door 2. Thus, the cold air flows into the electrical component installing chamber 11 through an upper portion thereof and flows backwards to the rear wall of the electrical component installing chamber 11, and then the cold air flows downwards to a bottom wall of the electrical component installing chamber 11 and finally flows forwards to the drawer door 2 and the hot air formed therein is discharged out of the lower portion of the electrical component installing chamber 11. In above processes, the cold air cools the electrical component while flowing therethrough, and the flowing directions of the cold air and the hot air are opposite the unidirectional arrows in FIG. 2.

According to an embodiment of the present disclosure, the plurality of kinds of vents 12 may include the air inlet 121, the air outlet 122 and an auxiliary air port, the air inlet 121 and the air outlet 122 are provided in one of the control box 3 and the drawer door 2, and the auxiliary air port is provided in the other one of the control box 3 and the drawer door 2. In other words, when the air inlet 121 and the air outlet 122 are provided in the control box 3, the auxiliary air port is provided in the drawer door 2, and at this time, the cold air enters the electrical component installing chamber 11 through the upper portion of the electrical component installing chamber 11 and turns into the hot air after cooling the electrical component, and the hot air is discharged out of the upper portion of the electrical component installing chamber 11. Also, the cold air may also enter the electrical component installing chamber 11 through the drawer door 2, or the hot air may also be discharged out of the drawer door 2.

When the air inlet 121 and the air outlet 122 are provided in the drawer door 2, the auxiliary air port is provided in the control box 3, and at this time, the cold air enters the electrical component installing chamber 11 through the drawer door 2 and turns into the hot air after cooling the electrical component, and the hot air is discharged from the drawer door 2. Also, the cold air may also enter the electrical component installing chamber 11 through the upper portion thereof, or the hot air may also be discharged out of the upper portion of the electrical component installing chamber 11.

The microwave heating device 100 according to a specific embodiment of the present disclosure will be described in the following with reference to the drawings. It may be understood that following descriptions only are exemplary, and not construed to limit the present disclosure.

As shown in FIGS. 1 and 2, the microwave heating device 100 according to the embodiment of the present disclosure includes an oven body 1, a drawer door 2 and a control box 3.

Specifically, the oven body 1 has a microwave heating chamber 10 and an electrical component installing chamber 11 therein, and a fan 4, a magnetron 5, a waveguide tube 6 and other electrical components are installed in the electrical component installing chamber 11. The electrical component installing chamber 11 has a plurality of kinds of vents 12 communicating with outside air, and the plurality of kinds of vents 12 includes an air inlet 121 and an air outlet 122. The drawer door 2 is movably installed on the oven body 1 to open and close the microwave heating chamber 10. In the drawings, the drawer door 2 is in a state in which the drawer door 2 closes the microwave heating chamber 10, and the air inlet 121 is provided in a bottom wall of the drawer door 2. The control box 3 is installed on the oven body 1 and located above the drawer door 2, the air outlet 122 is provided in a front surface of the control box 3, and the air outlets 122 are obround holes extended in a left and right direction and arranged in a plurality of rows in the left and right direction and in a plurality of columns in an up and down direction respectively. The control box 3 includes a control panel (not shown) facing forwards and the control panel avoids vents 12 disposed in the front surface of the control box 3. A plurality of kinds of intercommunicated holes is provided in the oven body 1 and includes an air-out intercommunicated hole 13 and an air-in intercommunicated hole 14, and the air outlet 122 communicates with the electrical component installing chamber 11 via the air-out intercommunicated hole 13 and the air inlet 121 communicates with the electrical component installing chamber 11 via the air-in intercommunicated hole 14.

Cold air is sucked into a lower portion of the electrical component installing chamber 11 by the fan 4 and flows backwards to a rear wall of the electrical component installing chamber 11, and then the cold air flows from bottom to top to a top wall of the electrical component installing chamber 11 and further flows forwards to pass through the magnetron 5, the waveguide tube 6 and other electrical components in turn so as to cool the these electrical components and have the microwave heating chamber 10 heat the food therein fully and evenly, and finally the cold air turns into hot air and the hot air is discharged from the air outlet 122. Thus, a gap between the control box 3 and the drawer 2 is reduced without affecting a heat dissipation efficiency of the microwave heating device 100.

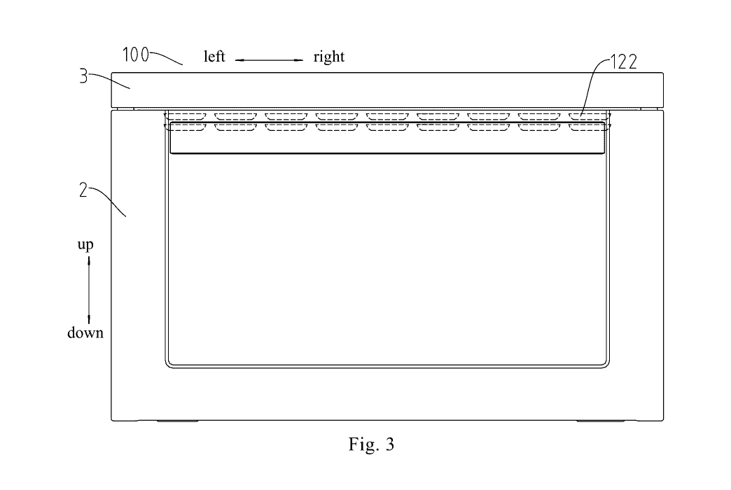

The microwave heating device 100 according to embodiments of the present disclosure will be described in the following with reference to FIGS. 3-8. The microwave heating device 100 has good appearance integrality, and is capable of taking in cold air and discharging out hot air so as to cool heating components and parts therein and improve a cooking effect thereof.

Specifically, the microwave heating device 100 may be microwave oven or a microwave roaster embedded into a wall or a cabinet.

As shown in FIGS. 3-8, the microwave heating device 100 according to the embodiment of the present disclosure includes an oven body 1, a drawer door 2 and a control box 3.

Specifically, the oven body 1 has a microwave heating chamber 10 and an electrical component installing chamber 11 therein. Food to be heated is placed in the microwave heating chamber 10 to be heated in a microwave way, and the electrical component installing chamber 11 is adapted to install electrical components required by microwave heating. The electrical component includes a fan, a magnetron, a waveguide tube, a transformer, a capacitor and so on. It should be noted that, the electrical component in the embodiment of the present disclosure is not limited to this, and may be any electrical component used in the microwave heating device 100.

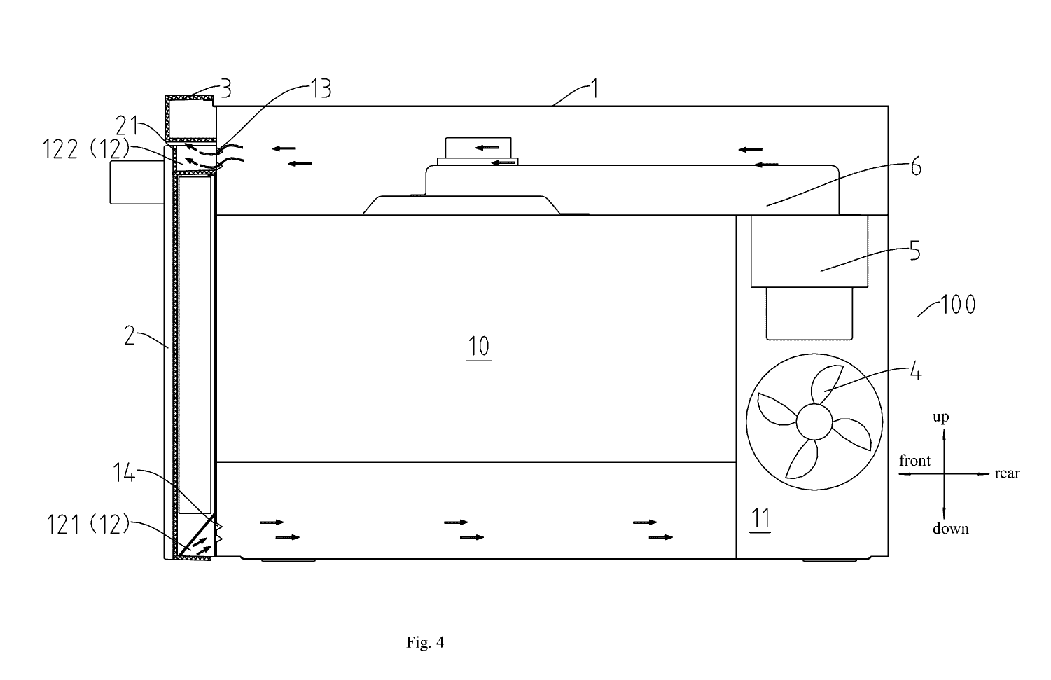

The electrical component installing chamber 11 has a plurality of kinds of vents 12 communicating with outside air. In this way, external cold air enters into the electrical component installing chamber 11 through a kind of vents 12 to cool the electrical components and then turns into the hot air, and then the hot air is discharged from another kind of vents 12, thus forming an air channel for air passage. Moreover, in above process, the flowing air have the heating in the microwave heating chamber 10 performed evenly, so as to improve the cooking effect of food. Unidirectional arrows in FIGS. 4, 6 and 8 are to indicate a flowing path of the air in the electrical component installing chamber 11, i.e., the above air channel. It may be understood that, the plurality of kinds of vents 12 may include an air outlet 122 and an air inlet 121.

The drawer door 2 is movably installed on the oven body 1 to open and close the microwave heating chamber 10, so that it is convenient for a user to put the food to be heated into the microwave heating chamber 10 or to take the food out of the microwave heating chamber 10. As shown in the drawings, the microwave heating device 100 is in a state in which the drawer door 2 closes the microwave heating chamber 10, and then the microwave heating device 100 can heat the food in the microwave heating chamber 10.

The control box 3 is installed on the oven body 1 and located above the drawer door 2. At least one kind of vents of the plurality of kinds of vents 12 are provided in the oven body 1, and the at least one kind of vents of the plurality of kinds of vents 12 are between the control box 3 and the drawer door 2. That is, all the plurality of kinds of vents 12 may be provided in the oven body 1, or only one kind of vents of the plurality of kinds of vents 12 may be provided in the oven body 1, or two kinds of vents of the plurality of kinds of vents 12 may be provided in the oven body 1. Thus, the cold air may enter in the electrical component installing chamber 11 through the gap between the control box 3 and the drawer door 2, or the hot air may be discharged out of the electrical component installing chamber 11 through the gap between the control box 3 and the drawer door 2. For example, as shown in the drawings, the air outlet 122 is provided in the oven body 1 and between the control box 3 and the drawer door 2.

A baffle 21 is disposed on the one of the drawer door 2 and the control box 3 so as to shield a portion of the gap between the control box 3 and the drawer door 2. Thus, the microwave heating device 100 has appearance integrality and leakproofness without affecting the cold air flow and hot air flow. For example, as shown in FIGS. 3, 5 and 7, viewed from the front of the microwave heating device 100, the baffle 21 can shield a portion of the gap between the control 3 and the drawer door 2, i.e., the gap between the control box 3 and the drawer door 2, which is visible from the front, is reduced.

With the microwave heating device 100 according to the embodiment of the present disclosure, by providing the baffle on the one of the drawer door 2 and the control box 3 so as to shield the portion of the gap between the control box 3 and the drawer door 2, the good appearance integrality and leakproofness are improved, and the cold air suction and hot air discharge of the microwave heating device 100 are not affected.

It should be noted that, following descriptions of the microwave heating device 100 are performed in the state in which the drawer door 2 closes the microwave heating chamber 10.

In an embodiment of the present disclosure, the baffle 21 may be disposed on the drawer door 2, extend towards the control box 3 from the drawer door 2, and spaced away from the control box 3. For example, as shown in FIG. 4, the baffle 21 is provided on an upper surface of the drawer door 2 and the baffle 21 extends upwards vertically, and an upper surface of the baffle 21 is spaced away from a lower surface of the control box 3. Thus, as shown in FIG. 3, the gap between the control box 3 and the drawer door 2 is reduced, the integrality and leakproofness of the microwave heating device 100 are improved, and it is ensured that the cold air or the hot air can flow through the gap. A path of the hot air flowing through the gap is illustrated as the unidirectional arrows in FIG. 4.

Optionally, a front surface of the baffle 21 is in flush with a front surface of the drawer door 2, which facilitates improving appearance aesthetics of the microwave heating device 100. For example, as shown in FIG. 4, the baffle 21 extends vertically from bottom to up, and the front surface of the baffle 21 is connected with the front surface of the drawer door 2.

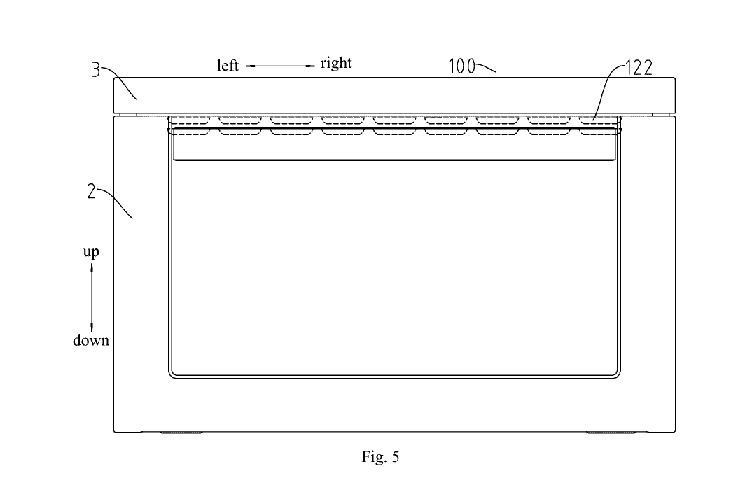

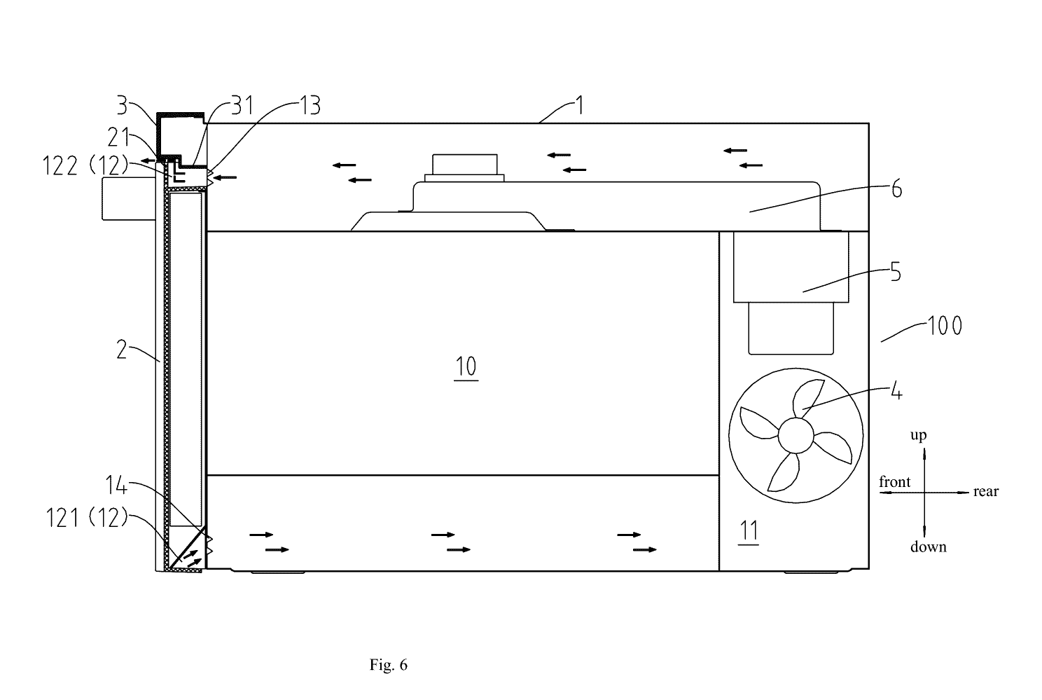

Furthermore, a boss 31 may be disposed on the control box 3 and protruded towards the drawer door 2, the at least one kind of vents of the plurality of kinds of vents 12 is located between the control box 3 and the drawer door 2, the boss 31 is located behind the baffle 21 and a lowest point of the boss 31 is lower than a highest point of the baffle 21. For example, as shown in FIG. 6, the boss 31 is located on the lower surface of the control box 3 and protruded downwards, the baffle 21 is in front of the boss 31, the upper surface of the baffle 21 is higher than the lower surface of the boss 31, and the air outlet 122 is between the control box 3 and the drawer door 2. In this way, as shown in FIG. 5, viewed from the front of the microwave heating device 100 by the user, the boss 31 is exposed to the gap between the control box 3 and the drawer door 2, and thus it is ensured that the vent 12 will not be present in a front visible region of the microwave heating device 100, thus further improving the appearance integrality and leakproofness of the microwave heating device 100 and ensuring that the cold air or the hot air can flow through the gap. A path of the hot air flowing through the gap is illustrated as the unidirectional arrows in FIG. 6.

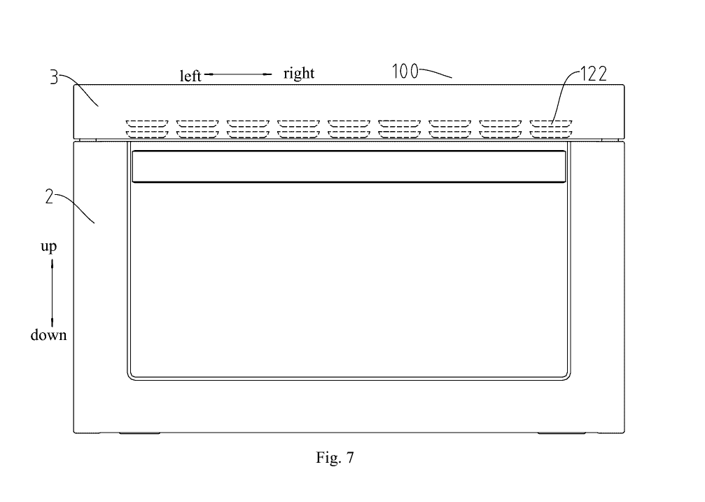

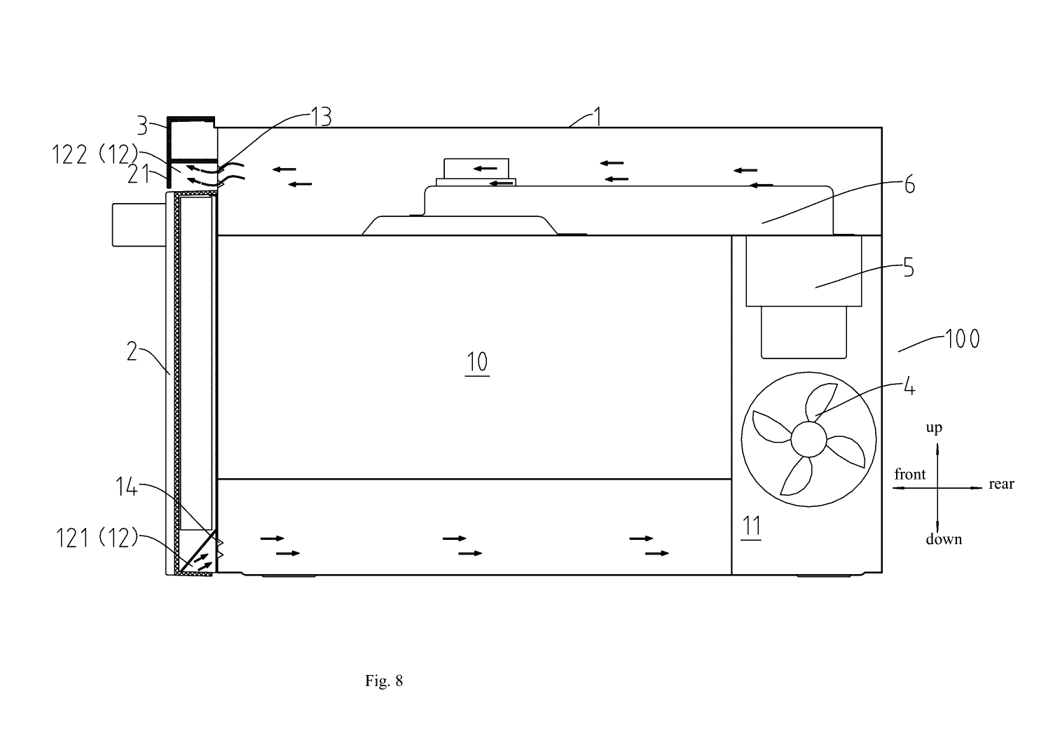

In an embodiment of the present disclosure, the baffle 21 may be disposed on the control box 3, and extend towards the drawer door 2 from the control box 3, and spaced away from the drawer door 2. For example, as shown in FIG. 8, the baffle 21 is disposed on the lower surface of the control box 3 and extends downwards vertically, and the lower surface of the baffle 21 is spaced away from the upper surface of the drawer door 2. Thus, as shown in FIG. 7, the gap between the control box 3 and the drawer door 2 is reduced, the integrality and leakproofness of the microwave heating device 100 are improved, and it is ensured that the cold air or the hot air can flow through the gap. A path of the hot air flowing through the gap is illustrated as the unidirectional arrows in FIG. 8.

Optionally, the front surface of the baffle 21 is in flush with a front surface of the control box 3, which facilitates improving appearance aesthetics of the microwave heating device 100. For example, as shown in FIG. 8, the baffle 21 extends vertically from up to bottom, and the front surface of the baffle 21 is connected with the front surface of the control box 3.

In embodiments as shown in FIGS. 4, 6 and 8, rest kinds of vents of the plurality of kinds of vents 12 apart from the vents provided in the oven body 1 are provided in the bottom wall of the drawer door 2. For example, the plurality of vents 12 includes the air outlet 122 and the air inlet 121. The air outlet 122 is provided in the oven body 1, and the air inlet 121 is provided in the bottom wall of the drawer door 2, thus further improving the appearance integrality and aesthetics of the microwave heating device 100 and also increasing a length of the air channel. Moreover, the cold air can flow through the whole electrical component installing chamber 11, and thus the heat dissipation efficiency of the microwave heating device 100 is increased and the cooking effect of the food is further improved.

Furthermore, at least one kind of the intercommunicated holes is provided in the oven body 1, and the plurality of kinds of vents 12 respectively communicates with the electrical component installing chamber 11 via a corresponding kind of intercommunicated holes. For example, as shown in FIGS. 4, 6 and 8, the air-out intercommunicated hole 13 and the air-in intercommunicated hole 14 are provided in the oven body 1, the air outlet 122 communicates with the electrical component installing chamber 11 via the air-out intercommunicated hole 13 and the air inlet 121 communicates with the electrical component installing chamber 11 via the air-in intercommunicated hole 14. Thus, the cold air entering the microwave heating device 100 through the air inlet 121 enters the electrical component installing chamber 11 through the air-in intercommunicated hole 14, and finally the hot air is discharged to the air outlet 122 through the air-out intercommunicated hole 13 and is further discharged out of the microwave heating device 100.

In some embodiments of the present disclosure, the plurality of kinds of vents 12 includes the air inlet 121 and the air outlet 122, one of the air inlet 121 and the air outlet 122 is provided in the oven body 1 and the other one of the air inlet 121 and the air outlet 122 is provided in the drawer door 2. In other words, as shown in FIGS. 4, 6 and 8, the air outlet 122 may be provided in the oven body 1 and between the control box 3 and the drawer door 2, and the air inlet 121 may be provided in the bottom wall of the drawer door 2. Thus, the cold air flows into the electrical component installing chamber 11 through the bottom wall of the drawer door 2 and flows backwards to a rear wall of the electrical component installing chamber 11, and then the cold air flows upwards to a top wall of the electrical component installing chamber 11 and finally flows forwards to the control box 3 and the hot air formed therein is discharged from the gap between the control box 3 and the drawer door 2. In above processes, the cold air cools the electrical component while flowing therethrough, and the unidirectional arrows in the drawings indicate flowing directions of the cold air and the hot air respectively.

Certainly, the air inlet 121 may be provided in the oven body 1 and the air outlet 122 may be provided in the bottom wall of the drawer door 2. Thus, the cold air flows into the electrical component installing chamber 11 through the oven body 1 and flows backwards to the rear wall of the electrical component installing chamber 11, and then the cold air flows downwards to a bottom wall of the electrical component installing chamber 11 and finally flows forwards to the drawer door 2 and the hot air formed therein is discharged from the bottom wall of the drawer door 2. In above processes, the cold air cools the electrical component while flowing therethrough, and the flowing directions of the cold air and the hot air are opposite the unidirectional arrows in the drawings.

In some embodiments of the present disclosure, the plurality of kinds of vents 12 may include the air inlet 121, the air outlet 122 and an auxiliary air port, the air inlet 121 and the air outlet 122 are provided in one of the oven body 1 and the drawer door 2, and the auxiliary air port is provided in the other one of the oven body 1 and the drawer door 2. In other words, when the air inlet 121 and the air outlet 122 are provided in the oven body 1, the auxiliary air port is provided in the drawer door 2, and at this time, the cold air enters the electrical component installing chamber 11 through an upper portion of the electrical component installing chamber 11 and turns into the hot air after cooling the electrical component, and the hot air is discharged out of the upper portion of the electrical component installing chamber 11. Also, the cold air may also enter the electrical component installing chamber 11 through the drawer door 2, or the hot air may also be discharged out of the drawer door 2.

When the air inlet 121 and the air outlet 122 are provided in the drawer door 2, the auxiliary air port is provided in the oven body 1, and at this time, the cold air enters the electrical component installing chamber 11 through drawer door 2 and turns into the hot air after cooling the electrical component, and the hot air is discharged out of drawer door 2. Also, the cold air may also enter the electrical component installing chamber 11 through the upper portion thereof, or the hot air may also be discharged out of the upper portion of the electrical component installing chamber 11.

The microwave heating device 100 according to a specific embodiment of the present disclosure will be described in the following with reference to FIGS. 3-4. It may be understood that following descriptions only are exemplary, and not construed to limit the present disclosure.

As shown in FIGS. 3 and 4, the microwave heating device 100 according to the embodiment of the present disclosure includes an oven body 1, a drawer door 2 and a control box 3.

Specifically, the oven body 1 has a microwave heating chamber 10 and an electrical component installing chamber 11 therein, and a fan 4, a magnetron 5, a waveguide tube 6 and other electrical components are installed in the electrical component installing chamber 11. The electrical component installing chamber 11 has a plurality of kinds of vents 12 communicating with outside air, and the plurality of kinds of vents 12 includes an air inlet 121 and an air outlet 122. The drawer door 2 is movably installed on the oven body 1 to open and close the microwave heating chamber 10. In the drawings, the drawer door 2 is in a state in which the drawer door 2 closes the microwave heating chamber 10, and the air inlet 121 is provided in a bottom wall of the drawer door 2. The control box 3 is installed on the oven body 1 and located above the drawer door 2, and the air outlet 122 is provided in the oven body 1 and between the control box 3 and the drawer door 2. A plurality of the air outlets 122 are provided and arranged in a plurality of rows in the left and right direction and in a plurality of columns in an up and down direction respectively. The baffle 21 is disposed on an upper surface of the drawer door 2 and extends upwards vertically, an upper surface of the baffle 21 is spaced away from a lower surface of the control box 3, and a front surface of the baffle 21 is in flush with a front surface of the drawer door 2. An air-out intercommunicated hole 13 and an air-in intercommunicated hole 14 are provided in the oven body 1, the air outlet 122 communicates with the electrical component installing chamber 11 via the air-out intercommunicated hole 13, and the air inlet 121 communicates with the electrical component installing chamber 11 via the air-in intercommunicated hole 14.

Cold air is sucked into a lower portion of the electrical component installing chamber 11 by the fan 4 and flows backwards to a rear wall of the electrical component installing chamber 11, and then the cold air flows from bottom to top to a top wall of the electrical component installing chamber 11 and further flows forwards to pass through the magnetron 5, the waveguide tube 6 and other electrical components in turn so as to cool the these electrical components and have the microwave heating chamber 10 heat the food therein fully and evenly, and finally the cold air turns into hot air and the hot air is discharged from an air channel formed by the drawer door 2, the control box 3 and the baffle 21. Thus, a gap between the control box 3 and the drawer 2 is reduced without affecting a heat dissipation efficiency of the microwave heating device 100.

With the microwave heating device 100 according to the embodiment of the present disclosure, good appearance integrality is obtained, and the cold air suction and hot air discharge of the microwave heating device 100 are not affected.

The microwave heating device 100 according to a first optional embodiment of the present disclosure will be described in the following with reference to FIGS. 5-6. It may be understood that following descriptions only are exemplary, and not construed to limit the present disclosure.

As shown in FIGS. 5 and 6, the microwave heating device 100 according to the embodiment of the present disclosure includes an oven body 1, a drawer door 2 and a control box 3.

Configurations and position relationships of the oven body 1, the drawer door 2 and the control box 3 are the same with those in the above microwave heating device 100 according to the specific embodiment of the present disclosure. It should be noted that a boss 31 is disposed on the lower surface of the control box 3 and protruded downwards, the baffle 21 is in front of the boss 31, the upper surface of the baffle 21 is higher than the lower surface of the boss 31, and the air outlet 122 is between the control box 3 and the drawer door 2.

A process for cooling the electrical component by the cold air is the same with the above process, which is omitted herein. Finally, the hot air is discharged from the air channel formed by the drawer door 2, the baffle 21, the boss 31 and the control box 3. Thus, the gap between the control box 3 and the drawer door 2 is reduced without affecting the heat dissipation efficiency of the microwave heating device 100.

With the microwave heating device 100 according to the embodiment of the present disclosure, good appearance integrality is obtained, and a heat dissipation effect of the microwave heating device 100 is not affected.

The microwave heating device 100 according to a second optional embodiment of the present disclosure will be described in the following with reference to FIGS. 7-8. It may be understood that following descriptions only are exemplary, and not construed to limit the present disclosure.

As shown in FIGS. 7 and 8, the microwave heating device 100 according to the embodiment of the present disclosure includes an oven body 1, a drawer door 2 and a control box 3.

Specifically, the oven body 1 has a microwave heating chamber 10 and an electrical component installing chamber 11 therein, and a fan 4, a magnetron 5, a waveguide tube 6 and other electrical components are installed in the electrical component installing chamber 11. The electrical component installing chamber 11 has a plurality of kinds of vents 12 communicating with outside air, and the plurality of kinds of vents 12 includes an air inlet 121 and an air outlet 122. The drawer door 2 is movably installed on the oven body 1 to open and close the microwave heating chamber 10. In the drawings, the drawer door 2 is in a state in which the drawer door 2 closes the microwave heating chamber 10, and the air inlet 121 is provided in a bottom wall of the drawer door 2. The control box 3 is installed on the oven body 1 and located above the drawer door 2, and the air outlet 122 is provided in the oven body 1 and between the control box 3 and the drawer door 2. A plurality of the air outlets 122 are provided and arranged in a plurality of rows in the left and right direction and in a plurality of columns in an up and down direction respectively. The baffle 21 is disposed on a lower surface of the control box 3 and extends downwards vertically, a lower surface of the baffle 21 is spaced away from an upper surface of the drawer door 2, and a front surface of the baffle 21 is in flush with a front surface of the control box 3. An air-out intercommunicated hole 13 and an air-in intercommunicated hole 14 are provided in the oven body 1, the air outlet 122 communicates with the electrical component installing chamber 11 via the air-out intercommunicated hole 13, and the air inlet 121 communicates with the electrical component installing chamber 11 via the air-in intercommunicated hole 14.

A process for cooling the electrical component by the cold air is the same with the above process, which is omitted herein. Finally, the hot air is discharged from the air channel formed by the drawer door 2, the control box 3 and the baffle 21. Thus, the gap between the control box 3 and the drawer door 2 is reduced without affecting the heat dissipation efficiency of the microwave heating device 100.

With the microwave heating device 100 according to the embodiment of the present disclosure, good appearance integrality is obtained, and a heat dissipation effect of the microwave heating device 100 is not affected.

In the specification, unless specified or limited otherwise, relative terms such as “up”, “down”, “front”, “rear”, “left”, “right”, “horizontal”, “vertical”, “top”, “bottom”, “inner”, “outer”, as well as derivative thereof should be construed to refer to the orientation as then described or as shown in the drawings under discussion for simplifying the description of the present disclosure, but do not alone indicate or imply that the device or element referred to must have a particular orientation, and be constructed or operated in a particular orientation. Thus, these terms shall not be construed to limit the present disclosure.

In the description of the present disclosure, unless specified or limited otherwise, it should be noted that, terms “installed,” “connected” and “coupled” may be understood broadly, such as permanent connection or detachable connection, electronic connection or mechanical connection, direct connection or indirect connection via intermediary, inner communication or interreaction between two elements. These having ordinary skills in the art should understand the specific meanings in the present disclosure according to specific situations.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A microwave heating device, comprising:
an oven body defining a microwave heating chamber and an electrical component installing chamber therein, the electrical component installing chamber communicating with outside air via a plurality of kinds of vents;
a drawer door movably installed on the oven body to open and close the microwave heating chamber; and
a control box installed on the oven body and located above the drawer door;
wherein at least one of the control box and the oven body has at least one kind of vents of the plurality of kinds of vents.

2. The microwave heating device according to claim 1, wherein the at least one kind of vents of the plurality of kinds of vents is provided in the control box.

3. The microwave heating device according to claim 2, wherein the at least one kind of vents of the plurality of kinds of vents is provided in a front surface of the control box.

4. The microwave heating device according to claim 3, wherein the control box comprises a control panel facing forwards and the control panel avoids vents disposed in the front surface of the control box.

5. The microwave heating device according to claim 2, wherein rest kinds of vents of the plurality of kinds of vents apart from the at least one kind of vents provided in the control box are provided in the drawer door.

6. The microwave heating device according to claim 5, wherein the rest kinds of vents of the plurality of kinds of vents are provided in a bottom wall of the drawer door.

7. The microwave heating device according to claim 5, wherein a plurality of kinds of intercommunicated holes is provided in the oven body, and the plurality of kinds of vents respectively communicates with the electrical component installing chamber via the plurality of kinds of intercommunicated holes.

8. The microwave heating device according to claim 2, wherein the plurality of kinds of vents comprises an air inlet and an air outlet, one of the air inlet and the air outlet is provided in the control box and the other one of the air inlet and the air outlet is provided in the drawer door.

9. The microwave heating device according to claim 2, wherein the plurality of kinds of vents comprises an air inlet, an air outlet and an auxiliary air port, the air inlet and the air outlet are provided in one of the control box and the drawer door, and the auxiliary air port is provided in the other one of the control box and the drawer door.

10. The microwave heating device according to claim 1, wherein the at least one kind of vents of the plurality of kinds of vents is provided in the oven body and between the control box and the drawer door, and a baffle is disposed on the one of the drawer door and the control box so as to shield a portion of the gap between the control box and the drawer door.

11. The microwave heating device according to claim 10, wherein the baffle is disposed on the drawer door, extends towards the control box from the drawer door, and spaced away from the control box.

12. The microwave heating device according to claim 11, wherein a front surface of the baffle is in flush with a front surface of the drawer door.

13. The microwave heating device according to claim 11, wherein a boss is disposed on the control box and protruded towards the drawer door, the at least one kind of vents of the plurality of kinds of vents is located between the control box and the drawer door, the boss is located behind the baffle and a lowest point of the boss is lower than a highest point of the baffle.

14. The microwave heating device according to claim 10, wherein the baffle is disposed on the control box, and extends towards the drawer door from the control box, and spaced away from the drawer door.

15. The microwave heating device according to claim 14, wherein a front surface of the baffle is in flush with a front surface of the control box.

16. The microwave heating device according to claim 10, wherein rest kinds of vents of the plurality of kinds of vents apart from the at least one kind of vents provided in the oven body are provided in the drawer door.

17. The microwave heating device according to claim 16, wherein the rest kinds of vents of the plurality of kinds of vents apart from the at least one kind of vents provided in the oven body are provided in a bottom wall of the drawer door.

18. The microwave heating device according to claim 16, wherein at least one kind of intercommunicated holes is provided in the oven body, and the plurality of kinds of vents respectively communicates with the electrical component installing chamber via a corresponding kind of intercommunicated holes.

19. The microwave heating device according to claim 10, wherein the plurality of kinds of vents comprises an air inlet and an air outlet, one of the air inlet and the air outlet is provided in the oven body and the other one of the air inlet and the air outlet is provided in the drawer door.

20. The microwave heating device according to claim 10, wherein the plurality of kinds of vents comprises an air inlet, an air outlet and an auxiliary air port, the air inlet and the air outlet are provided in one of the oven body and the drawer door, and the auxiliary air port is provided in the other one of the oven body and the drawer door.
